(19) United States
(12) Patent Application Publication
(10) Pub. No.: US 2006/0219694 A1
(43) Pub. Date: Oct. 5, 2006

(54) Application device for driving aromatherapeutic particles

(76) Inventor: Chia-Hsiung Wu, Taipei (TW)

Correspondence Address: Chia-Hsiung Wu, P.O. Box No. 6-57, Junghe, Taipei 235, TW

(21) Appl. No.: 11/094,162

(22) Filed: Mar. 31, 2005

(51) Int. Cl. F27D 11/00

(52) U.S. Cl. 219/400

(57) ABSTRACT

An application device for driving aromatherapeutic particles, in that the application device provides safe and constant temperatures for activating aromatherapeutic particles through a medium material having a high evaporation temperature, such that aromatherapeutic particle elements having intact and complete structures are evenly liberated and released. The application device comprises a heating device having an operating temperature which disengages aromatherapeutic particles and is lower than an evaporation temperature of a fragrance discharging body. The heating device indirectly heats the aromatherapeutic particles of the herbal material contained in the medium, and achieves a constant temperature through self-heat-exchange of the medium while also liberates the aromatherapeutic elements. Thereby, the aromatherapeutic particles maintained with intact and complete structures are discharged outwards using heat circulation, and are released With stable amounts.

### BACKGROUND OF THE INVENTION

(a) Field of the Invention

The invention relates to an application device for driving aromatherapeutic particles, and more particularly, to an application device for driving aromatherapeutic particles, in that the application device comprises a medium having a high evaporation temperature and indirectly activating aromatherapeutic particles, thereby disengaging and releasing aromatherapeutic particle having complete element structures with quantitative amounts.

(b) Description of the Prior Art

Prior indoor odor adjustment methods can be as simple as spraying liquid scent, or releasing essence contained in herbs by means of burning, so as to fill an environment with a pleasant smell. Recently, scented candles are burnt or essence oils are vaporized using heat to release aromatherapeutic particles and then fill an indoor environment for indoor odor adjustment, or to further obtaining sterilization effects using chemical functions thereof, or even to soothe and calm human sense organ nerves through biological functions thereof.

Referring to FIG. 1 showing an example of a scented candle, a scented candle 1 comprises aromatherapeutic elements 10. When a flame 12 is formed by burning a pith 11, the scented candle 1 is melted by a temperature of the flame 12 to simultaneously oxidize the aromatherapeutic elements 10, which are then diffused into an indoor environment.

Referring to FIG. 2 showing a recent odor adjustment method using an essence, a pot 2 is placed with water 22 therein, and an aromatherapeutic essence film 20 provided at a water surface. The pot 2 has a bottom section thereof supported by a rack 21. A flame 24 is formed within the rack 21 to boil the water 22. Heat acquired by the water 22 is transmitted to the film 20 to further evaporate the film 20.

However, due to vigorous oxidation process imposed by burning of the flame 12, compositions of the aromatherapeutic elements 10 contain in the scented candle 1 are frequently damaged. Hence, using the method of scented candles, scents spread out are often changed in addition to strong chemical smells. Also, humidity is increased because carbohydrates are formed accompanied with burning of the flame 12.

Again, regarding the aforesaid boiling method, the aromatherapeutic essence film 20 is floated on the surface of the water 22, and the film 20 located at a corner 230 is likely to adhere to an inner surface 23 of the pot 2 due to heat transmission of the pot 2. Furthermore, a level of the water 22 is lowered after a certain period of evaporation from boiling by heat transmission effects of the flame 24, thus the aromatherapeutic essence film 20 at the corner 230 remains attached to the inner surface of the pot 2. It is to be noted that a periphery of the pot 2 is given a same high temperature from heat transmission effects of the flame 24, and therefore a temperature of the inner surface 23 is higher than that of the surface of the water 22. As a result, high-temperature reactions are incurred at the aromatherapeutic essence film 20 to change scent structures of the aromatherapeutic essence film 20 or even scorch the aromatherapeutic essence film 20.

Apart from the aforesaid drawbacks, the prior method by boiling the water 22, owing to being floated on the water surface, the aromatherapeutic essence film 20 is prone to direct and rapid evaporation from the water surface from boiling the water 22, meaning that effective lifespan of the aromatherapeutic essence film 20 is reduced. Supposed the a large amount of essence is placed in the pot 2 to leave floating on the surface of the water 22, the flame may directly burn the aromatherapeutic essence the water 22 when the water 22 is totally evaporated from heating by the flame 24. When directly heated by the flame 24, the aromatherapeutic essence is reacted with high temperatures to change structures of the aromatherapeutic particles therein and similarly producing particles with scorched or other discomforting smells.

### SUMMARY OF THE INVENTION

In view of numerous drawbacks of the prior invention, the primary object of the invention is to provide a novel application device for driving aromatherapeutic particles. The application device according to the invention, using an indirect activation method, comprises a medium material having a high evaporation temperature, wherein the medium is melted into a fluid when heated. After storing the heat, the heat energy is indirectly acted upon aromatherapeutic elements of an herbal material of an aromatherapeutic essence. For that the medium material is capable of temporarily containing the aromatherapeutic elements and is constantly heated, a self-circulation operation is formed using the heat, thereby gradually liberating the aromatherapeutic elements with stable amounts while also ensuring intact and complete structures of the aromatherapeutic elements.

The other object of the invention is to provide an application device for driving aromatherapeutic particles, in that the application device comprises a temperature-constant heating device made of ceramic resistor heating plates having a positive temperature coefficient. The temperature-constant heating device is for ensuring a steady operating temperature and thus preventing different heat reactions of the aromatherapeutic particles, thereby maintaining intact and complete structures of the aromatherapeutic elements released with stable amounts.

To better understand the invention, detailed descriptions shall be given with the accompanying drawings below.

### BRIEF DESCRIPTION OF THE DRAWINGS

FIG. 1 shows a side view of a prior scented candle.

FIG. 2 shows a side view of an example of a prior device using a boiling method for releasing an aromatherapeutic essence.

FIG. 3 shows a side view of a discharging body according to the invention.

FIG. 4 shows an elevational view of a block-like discharging body according to the invention.

FIG. 5 shows a structural side view of a heating device in another embodiment according to the invention.

FIG. 6 shows a side view illustrating operation of replacing an herbal material using a filter net according to the invention.

FIG. 7 shows a side of an intermittent supply method for supplying an aromatherapeutic essence according to the invention.

FIG. 8 shows another embodiment according to the invention.

FIG. 9 shows yet another embodiment according to the invention.

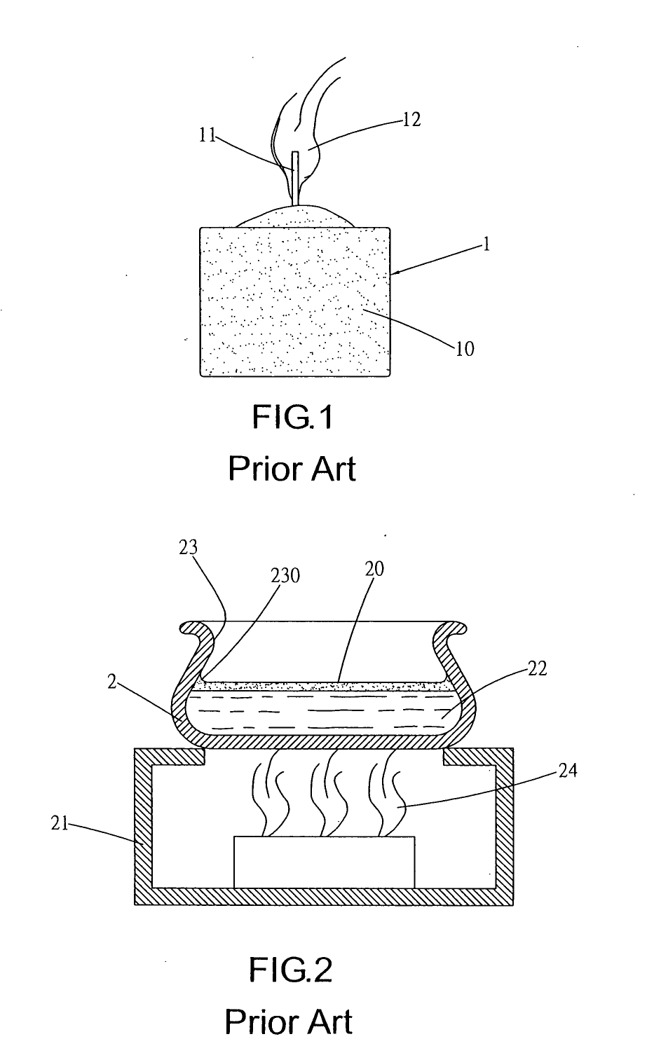

### DETAILED DESCRIPTION OF THE PREFERRED EMBODIMENTS

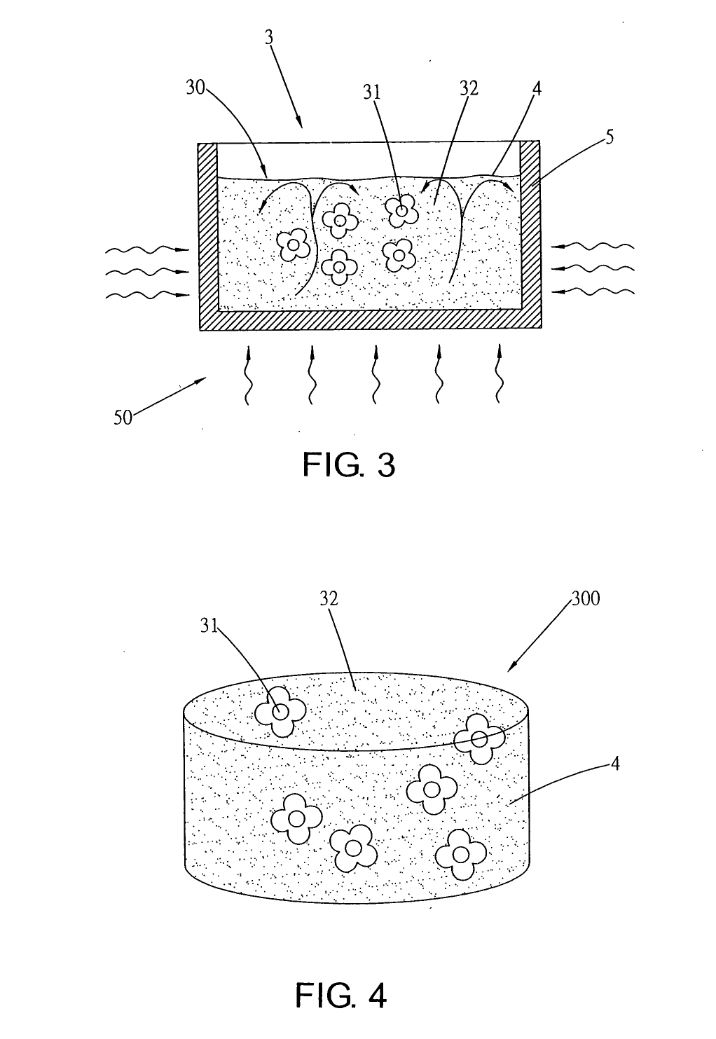

Referring to FIG. 3 showing an embodiment according to the invention, the invention comprises a wax medium 4 containing an aromatherapeutic element 3 to form a fragrance discharging body 30. The wax medium 4 is a heat-fusing material, and becomes molten when accepting a heat temperature of 60 degrees Celsius. In addition, the wax medium 4 is held within a container 5 to acquire heat from externally applied heat waves 50 transmitted via the container 5, and is filled with an herbal material 31 or infused with an aromatherapeutic essence 32. The wax material 4 has an evaporation temperature of higher than 130 degrees Celsius, and usually accepts a temperature of around 80 degrees Celsius. Under circumstances of having a temperature of 80 degrees Celsius that is much less than the evaporation temperature, the heated medium 4 maintains structures thereof intact and undamaged, but only appears as a molten state. Furthermore, the medium 4 is constituted by mineral oils or natural oils, which provide affinity with the oil-like aromatherapeutic elements contained in the herbal material 31 or the aromatherapeutic essence 32, and therefore oil-like aromatherapeutic elements or aromatherapeutic essence can be contained without any conflict.

The medium 4 accepts temperatures ranging between 80 and 100 degrees Celsius, and is melted into a fluid at 60 degrees Celsius, which activates and liberates aromatherapeutic elements contained in the herbal material 31 or the aromatherapeutic essence 32. Using energy generated by circulation of the fluid, the aromatherapeutic elements contained in the herbal material 31 are guided out, and become melted in the medium 4. Thus, when the medium 4 is heated, apart from guiding out the aromatherapeutic elements in the herbal material 31 or liberating aromatherapeutic ingredients by reacting on the aromatherapeutic essence 32, the aromatherapeutic particles at a lower section of the medium 4 are distributed to an upper surface of the medium 4 in an upward direction using the circulation and static energy caused by uneven heat from the heat waves 50 upon the container 5.

When being distributed at an uppermost section, the aromatherapeutic particles are similarly driven by the heat energy to remain uncontained in a liberated state to infuse into an indoor environment. Consequently, the aromatherapeutic elements in the herbal material 31 or the aromatherapeutic essence 32 are constantly activated to be mildly and gradually liberated.

For that heat reaction temperatures range between 80 and 100 degrees Celsius, compositions of the aromatherapeutic element particles in the herbal material 31 and the aromatherapeutic essence 32 are allowed with intact and complete structures, thereby enabling the aromatherapeutic particles to approach 100% infusion capacity. According to the invention, smells of the aromatherapeutic elements are the same before and after being released, and amount thereof being released are maintained the same as well after smelling from distances nearby.

Referring to FIG. 4, the wax medium 4 is a heat-fusing material, and thus becomes a fluid when melted using heat and stays in a solid state under room temperature (lower than a melting temperature thereof). When the wax medium 4 is under a molten stated when heated, the herbal material 31 or the aromatherapeutic essence 32 is filled therein so as to contain the herbal material 31 or the aromatherapeutic essence 32 in the medium 4. When cooled by room temperature, a block-like, three-dimensional discharging body 300 is formed for facilitating packaging, storage or dividing into amounts as desired for application. Wherein, a shape of the block-like discharging body 300 can be animal designs or any other geometric three-dimensional shapes according to a user's requirements.

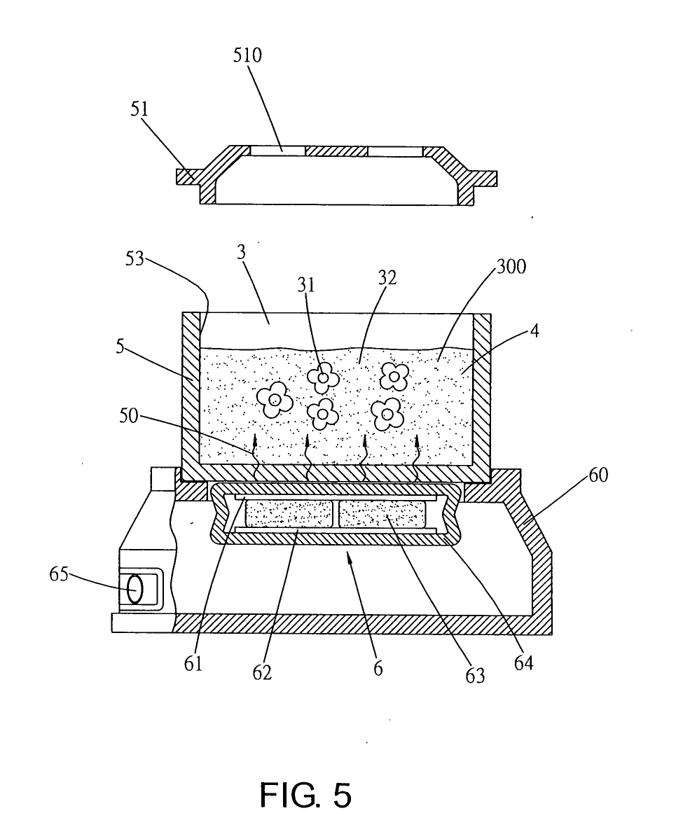

Referring to FIG. 5, the aforesaid fragrance discharging body 30 or the block-like discharging body 300 accepts heat via a container 5. The container 5 has an internal space for placing the fragrance discharging body 30 or the block-like discharging body 300, and receives externally applied heat waves 50 transmitted from a temperature-constant heating device 6. The temperature-constant heating device 6 comprises positive temperature coefficient ceramic resistor heating plates 63 for generating heat. The heating plates 63 have corresponding surfaces thereof devised with electrode plates 61 and 62 for conducting electricity, and are surrounded by a heat-conducting frame 64 for insulation. Heat generated from electricity conducted using resistance by the heating plates 63 is indirectly transmitted to the container 5 via the heat-conducting frame 64, and the acting heat waves 50 then enter into the container 5 to act upon the discharging body 30 or the block-like discharging body 300. Hence, the medium 4 of the discharging body 30 is melted by the heat, such that the aromatherapeutic elements of the herbal material 31 and the aromatherapeutic essence 32 become circulated as shown in FIG. 3, and are liberated outwards using flowing effects thereof.

To avoid an inner surface 53 of the container from adhering to any undesired substances, the inner surface 53 is provided as a smooth surface that facilitates the oils coming off. In addition, for protection purposes, an upper opening of the container 5 is devised with a protective cover 51, which has ventilation openings 510 for discharging internal aromatherapeutic air.

The temperature-constant heating device 6 operating based on electricity adopts a power-selective switch 65 for adjusting magnitudes of power, so as to change temperatures of heating device 6. Temperatures of the heating device 6 are modulated according to temperature requirements for evaporating different aromatherapeutic elements. For instance, an activation temperature of the aromatherapeutic essence 32 is lower than that of the herbal material 31, thus a temperature for activating the aromatherapeutic essence 32 can be controlled at a lowest temperature possible. However, since it is necessary that the herbal material 31 be heated again to perform depth induction of arormatherapeutic compositions contained therein, higher temperatures are utilized for completing such induction. Or, for ligneous plants, higher power is even needed to guide out the aromatherapeutic particles within the ligneous fiber tissues. Therefore, the design of the power-selective switch 65 provides solutions corresponding to requirements regarding heat needed for liberating different aromatherapeutic elements 3; however, a highest temperature is to be maintained below the evaporation temperature of the medium 4.

The ceramic resistor heating plates 63 are made of ceramic resistors having a positive temperature coefficient, and are characterized as capable of generating expected temperatures according to hardware specifications. Moreover, the ceramic resistor heating plates 63 have a self-controlled temperature heating property, and thus a temperature obtained by the medium 4 stays at a constant temperature for providing the aromatherapeutic elements 3 with steady effects, thereby inducing and liberating the aromatherapeutic particles with stable amounts as well as preventing undesired reactions caused by fluctuating temperatures upon the medium 4.

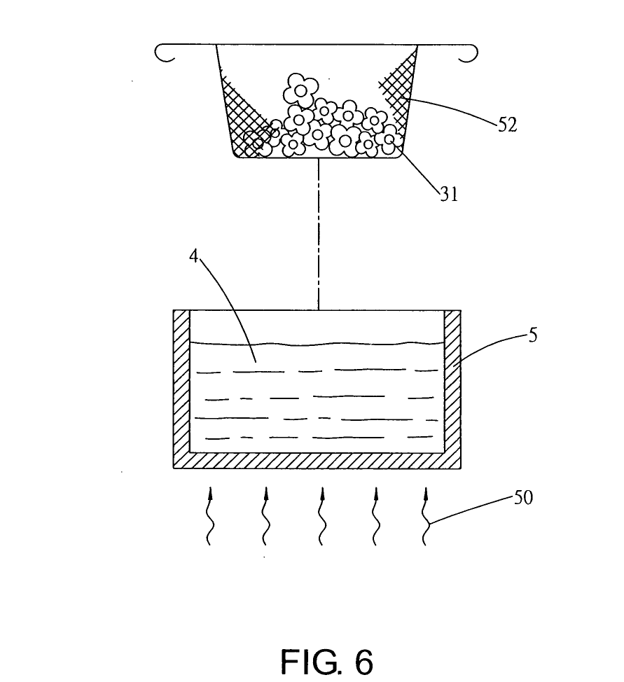

Referring to FIG. 6, when being heated by the heat waves 50, the container 5 is provided with a temperature sufficient for melting the medium 4 therein. The medium 4 is then enabled to release and induce the aromatherapeutic particles of the herbal material 31.

The invention may also further utilize a filter net 52 having an accommodating space for holding the herbal material 31, such that the herbal material 31 is dipped in the medium 4 in a suspended manner. When the medium 4 is heated and the aromatherapeutic elements in the herbal material 31 are completely released, residues of the herbal material 31 are taken out and a new herbal material is replaced therein. For that surfaces of the residual herbal material are attached with the wax medium 4, the residual herbal material can serve purposes as tinder for igniting flames to avoid environmental pollution. Or, the herbal material 31 can be long-term decorative objects by attaching the wax medium 4 according to shapes and appearances thereof.

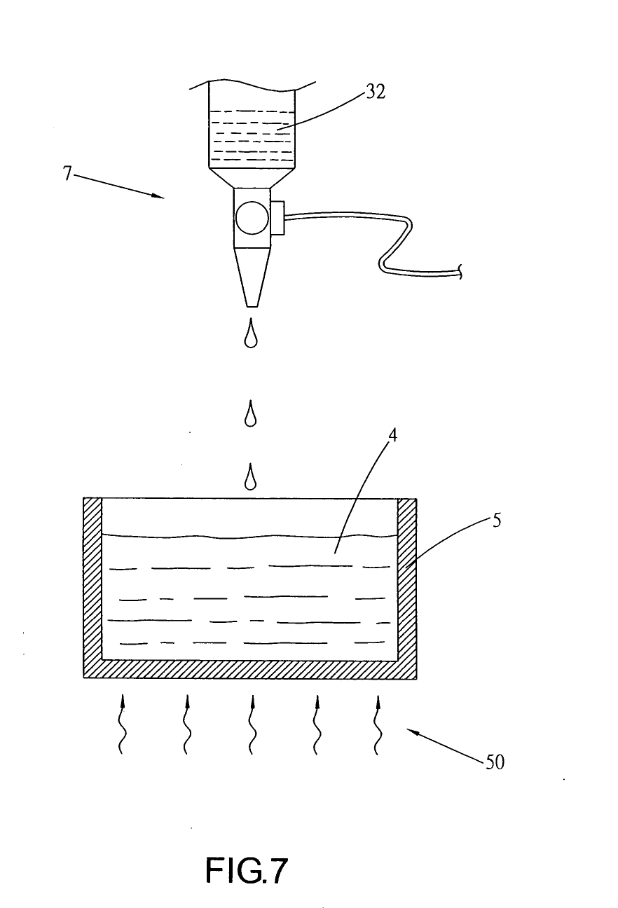

Referring to FIG. 7, when the container 5 is heated by the heat waves 50 for melting the medium 4, the medium 4 becomes a fluid in the container 5. In order to provide long-lasting fragrant effects, an intermittent supply device 7 is used for intermittently refilling the aromatherapeutic essence 32. Through the intermittent supply device 7, the aromatherapeutic essence 32 may be refilled by dripping or other electromechanical control methods, such that the aromatherapeutic essence 32 is quantitatively and periodically supplied for giving aromatherapeutic particles further to be released by the medium 4. The evaporation temperature of the medium 4 is much higher than the evaporation temperature of the aromatherapeutic essence 32 and the temperature of the heat waves 50, and hence the medium 4 remains at a melted stated without being evaporated over a long period of time. Consequently, each drop of the aromatherapeutic essence 32 refilled is ensured to undergo heat reaction with a same volume of the medium 4, thereby discharging aromatherapeutic elements having intact structures with stable amounts. The embodiment shown in FIG. 7 can be applied to environments that need long-lasting fragrant effects - a lavatory or a bathroom for instance.

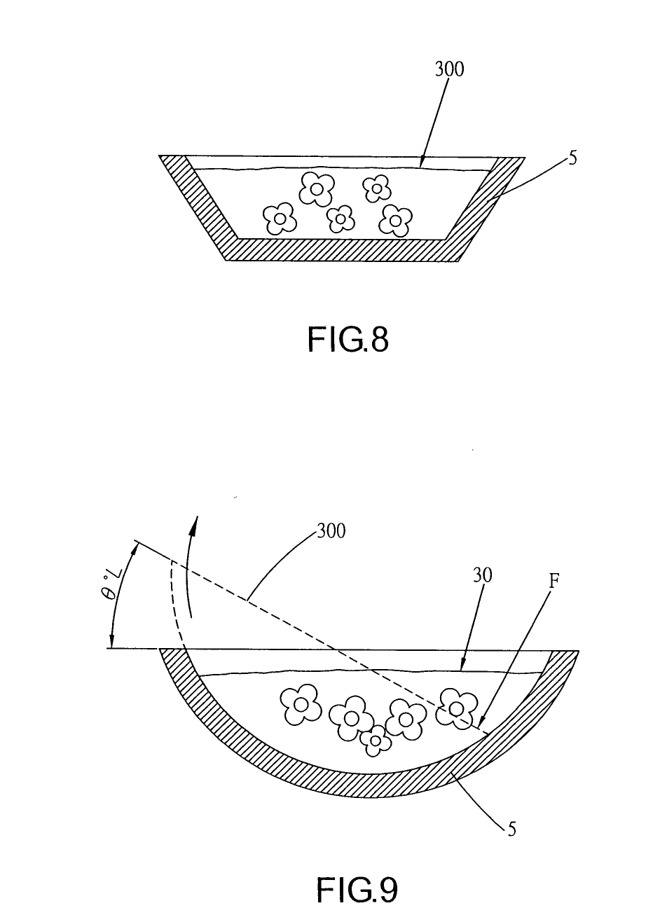

Referring to FIG. 8, an upper opening of the container 5 is devised as a cone shape having a dilated upper section and a contracted lower section, so as to provide the discharging body 30 with cooling effects using room temperature when placed therein, and to facilitate the discharging body 30 to disengage from the container 5 when cooled down to a block-like body.

Referring to FIG. 9, an inner surface of the container 5 is devised as an arched surface. When the discharging body is cooled by room temperature, a force F is imposed from an edge upon the discharging body to form an angle θ, such that the block-like discharging body 300 is likely disengaged from the container 5. The inner surface of the container 5 is also devised as a smooth surface that easily detaches from oils for facilitating disengagement of the discharging body 300, and can be accomplished by applying glaze or Teflon. In addition, the container 5 is preferably made of a heat-conductive material.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An application device for driving aromatherapeutic particles, in that the application device providing safe and constant temperatures for activating aromatherapeutic particles through a medium material having a high evaporation temperature such that aromatherapeutic particle elements having intact and complete structures are evenly liberated and released, comprising characteristics of a smell-less and heat-fusing wax medium having affinity with aromatherapeutic particles; wherein, the wax medium is filled with aromatherapeutic elements therein when melted, forms a three-dimensional block-like discharging body when cooled in room temperature, and has an evaporation temperature higher than that of the aromatherapeutic elements.

2. The application device for driving aromatherapeutic particles in accordance with claim 1, wherein the aromatherapeutic elements is a natural herbal aromatherapeutic essence.

3. The application device for driving aromatherapeutic particles in accordance with claim 1, wherein the aromatherapeutic elements is an herb having aromatherapeutic particles.

4. The application device for driving aromatherapeutic particles in accordance with claim 3, wherein the herb is a fresh herb.

5. The application device for driving aromatherapeutic particles in accordance with claim 3, wherein the herb is pre-processed by dehydration.

6. An application device for driving aromatherapeutic particles, in that the application device providing safe and constant temperatures for activating aromatherapeutic particles through a medium material having a high evaporation temperature such that aromatherapeutic particle elements having intact and complete structures are evenly liberated and released, comprising characteristics of a container;
wherein, the container is for holding a fragrance discharging body or a medium material, and has an inner surface thereof devised as a smooth surface for easily detaching from oils; and
an interior of the container accepts externally applied heat waves from a temperature-constant heating device made of ceramic resistors having a positive temperature coefficient, and a temperature within the container ranges approximately between 80 and 100 degrees Celsius.

7. The application device for driving aromatherapeutic particles in accordance with claim 6, wherein the container is provided with an intermittent supply device for aromatherapeutic essence above.

8. The application device for driving aromatherapeutic particles in accordance with claim 6, Wherein the temperature-constant heating device has an electric power-selective switch for adjusting power thereof.

9. The application device for driving aromatherapeutic particles in accordance with claim 6, wherein an inner section of the container is devised as an arched surface.

10. The application device for driving aromatherapeutic particles in accordance with claim 1, wherein the container has a filter net at an interior thereof for placing an herbal material.
